(19) United States
(12) Patent Application Publication
(10) Pub. No.: US 2017/0052693 A1
(43) Pub. Date: Feb. 23, 2017

(54) METHOD AND DEVICE FOR DISPLAYING A TARGET OBJECT

(71) Applicant: Xiaomi Inc., Beijing (CN)

(72) Inventors: Jianwei Cui, Beijing (CN); Liang Xie, Beijing (CN); Kai Qian, Beijing (CN); Dihao Chen, Beijing (CN)

(21) Appl. No.: 15/152,529

(22) Filed: May 11, 2016

(30) Foreign Application Priority Data
Aug. 19, 2015 (CN) 201510512105.X

(51) Int. Cl. G06F 3/0488; G06F 21/62; G06F 3/0484

(52) U.S. Cl. CPC G06F 3/04883; G06F 3/04845; G06F 3/04842; G06F 21/629; G06F 2203/04808; G06F 2203/04806

(57) ABSTRACT

Method and device for displaying a target object are provided. The method may include: detecting a multi-point touch event for the target object; determining whether the detected multi-point touch event is a predetermined first multi-point touch event, wherein the first multi-point touch event is used to trigger switching displaying of the target object to a private displaying mode; switching displaying of the target object to the private displaying mode if the detected multi-point touch event is the first multi-point touch event, such that only the target object is displayed in the private displaying mode.

### CROSS-REFERENCE TO RELATED APPLICATION

This application claims priority to Chinese Patent Application No. 201510512105X, filed on Aug. 19, 2015, which is incorporated herein by reference in its entirety.

### TECHNICAL FIELD

The present disclosure generally relates to the field of communication, and more particularly to a method and device for displaying a target object and a computer-readable medium.

### BACKGROUND

The users may deliver their mobile phones to their friends nearby when using the mobile phones, to show some messages and pictures in their mobile phones to their friends. Thus, it is desired to protect privacy of the users in such usage scenario so as to improve the user experience.

### SUMMARY

According to a first aspect of the present disclosure, a method for displaying a target object is provided, including: detecting multi-point touch event for the target object; determining whether the detected multi-point touch event is a predetermined first multi-point touch event, wherein the first multi-point touch event is used to trigger switching displaying of the target object to a private displaying mode; and switching displaying of the target object to the private displaying mode if the detected multi-point touch event is the first multi-point touch event, such that only the target object is displayed in the private displaying mode.

According to a second aspect of embodiments of the present disclosure, a device for displaying a target object including: a processor; and a memory for storing the instructions executable by the processor; wherein the processor is configured to: detect a multi-point touch event for the target object; determine whether the detected multi-point touch event is a predetermined first multi-point touch event, wherein the first multi-point touch event is used to trigger switching displaying of the target object to a private displaying mode; switch displaying of the target object to the private displaying mode if the detected multi-point touch event is the first multi-point touch event, such that only the target object is displayed in the private displaying mode.

According to a third aspect of the present disclosure, there is provided a non-transitory computer-readable storage medium having stored therein instructions that, when executed by a processor of a device, causes the device to perform a method for displaying a target object, the method including: detecting multi-point touch event for the target object; determining whether the detected multi-point touch event is a predetermined first multi-point touch event, wherein the first multi-point touch event is used to trigger switching displaying of the target object to a private displaying mode; switching displaying of the target object to the private displaying mode if the detected multi-point touch event is the first multi-point touch event, such that only the target object is displayed in the private displaying mode.

It is to be understood that both the forgoing general descriptions and the following detailed descriptions are exemplary and explanatory only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for displaying a target object according to an exemplary embodiment.

FIG. 2 is a flow chart illustrating a method for displaying a target object according to another exemplary embodiment.

FIG. 3 is an interactive interface illustrating displaying of a message according to an exemplary embodiment.

FIG. 4 is an interactive interface illustrating displaying of a message according to another exemplary embodiment.

FIG. 5 is an interactive interface illustrating displaying of a picture according to another exemplary embodiment.

FIG. 6 is an interactive interface illustrating displaying of a picture according to another exemplary embodiment.

FIG. 7 is a block diagram illustrating a device for displaying a target object according to an exemplary embodiment.

FIG. 8 is a block diagram illustrating a device for displaying a target object according to an exemplary embodiment.

FIG. 9 is a block diagram illustrating a device for displaying a target object according to an exemplary embodiment.

FIG. 10 is a block diagram illustrating a device for displaying a target object according to an exemplary embodiment.

FIG. 11 is a block diagram illustrating a device for displaying a target object according to an exemplary embodiment.

FIG. 12 is a block diagram illustrating a device for displaying a target object according to an exemplary embodiment.

FIG. 13 is a structure diagram illustrating a device for displaying a target object according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of device and methods consistent with aspects related to the invention as recited in the appended claims.

The terms used in present disclosure are merely for describing the particular embodiments rather than limiting the present disclosure. Terms, such as “a”, “an”, “said”, and “the”, as used in singular form in present disclosure and appended claims include plural form, unless otherwise represent other meaning clearly in the context. It also should be understood that the term “and/or” used herein indicates and comprises any or all of possible combinations of one or more associated items which have been listed.

It should be understood that the terms “first,” “second,” and “third,” may be used to describe various information, but it not limit to these terms. These terms are only used to separate the same type of the information from each other. For example, the first information may also be referred as the second information without departing from the scope of the present disclosure, similarly the second information may also be referred as the first information. The word “if” as used herein may be interpreted as “when” or “while” or “respond to determination” depending on the context.

The mobile phone users may deliver their mobile phones to their friends nearby when using the mobile phones, for showing some messages and pictures in the mobile phones to their friends. When showing the messages in the mobile phones to their friends nearby, some undesired messages may also be shown to their friends except for the message expected to be viewed, because generally there are multiple messages displayed on the screen of the mobile phone. Moreover, when showing the pictures in their mobile phones to their friends nearby, the undesired pictures may also be displayed by their friends' sliding forward or backward operations. That is, in this usage scenario, the way of showing the current messages and pictures may cause privacy disclosure although unintentionally.

In view of the foregoing, the present disclosure provides a method for displaying a target object. The method includes detecting a multi-point touch event for the target object, and determining whether the detected multi-point touch event is a predetermined first multi-point touch event. The first multi-point touch event is used to trigger switching displaying of the target object to a private displaying mode. The method further includes switching displaying the target object to the private displaying mode if the detected multi-point touch event is the first multi-point touch event, so that the user can implement switching displaying of the target object to the private displaying mode easily by performing simple multi-point touch operations, reducing the potential risk of privacy disclosure in a usage scenario where the user shows the target object to the other user(s).

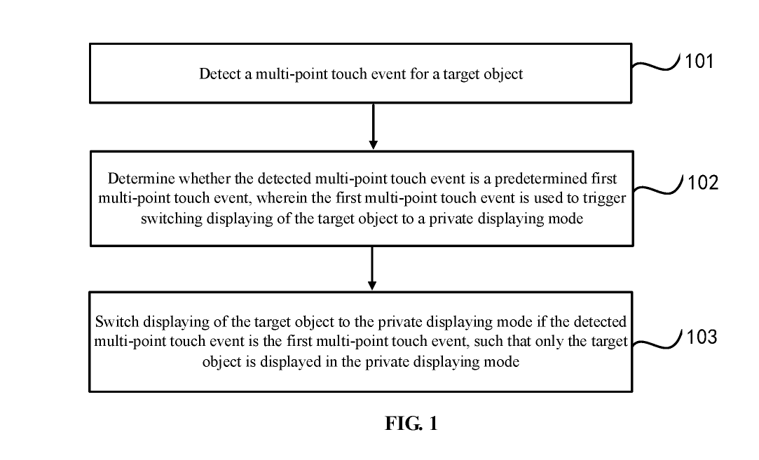

FIG. 1 illustrates a method for displaying a target object, which can be applied in a terminal, according to an exemplary embodiment. The method includes the following steps.

In step 101, a multi-point touch event for the target object is detected.

In step 102, it is determined whether the detected multi-point touch event is a predetermined first multi-point touch event, wherein the first multi-point touch event is used to trigger switching displaying of the target object to a private displaying mode.

In step 103, if the detected multi-point touch event is the first multi-point touch event, displaying of the target object is switched to the private displaying mode, such that only the target object is displayed in the private displaying mode.

The terminal mentioned above may be a mobile terminal. For example, the terminal may be a touch-screen smart phone of the user. The target object mentioned above may be a text object or an image object. For example, the target object may be a message on the user terminal or a picture on the user terminal. Alternatively, the target object may be any other type of object which can be configured as a showable target object, such as a multimedia object, a window object or the like. For example, the target object can also be a window of application or a multimedia interface on the user terminal.

In this embodiment, the particular multi-touch operation can be performed for the target object to be shown when the user wants to show the target object to the others, and displaying of the target object to be shown is switched to the private displaying mode.

The particular multi-touch operations mentioned above may be predetermined multi-touch operations. The predetermined multi-touch operations may include the first multi-point touch operation which is used to trigger switching displaying of the target object to the private displaying mode, and a second multi-point touch operation which is used to trigger restoring displaying of the target object from the private displaying mode to a default displaying mode.

Both the first multi-point touch operation and the second multi-point touch operation mentioned above may be a combination of predetermined touch operations. For example, the first multi-point touch operation may include a selecting operation for the target object and a zoom-in gesture operation accompanying the selecting operation. The second multi-point touch operation may include the selecting operation for the target object and a zoom-out gesture operation accompanying the selecting operation.

In an implementation illustrated in this embodiment, the selecting operation may be a long-press operation; the zoom-in gesture operation may be a two-finger-outward-sliding operation at any location on a screen when the user selects the target object by long-pressing it; and the zoom-out gesture operation may be a two-finger-inward-sliding operation at any location on the screen when user selects the target object by long-pressing it.

In the following, the gesture interaction process between the user and the terminal will be described in details with an example where the selecting operation is the long-press operation, the zoom-in gesture operation is the two-finger-outward-sliding operation and the zoom-out gesture operation is the two-finger-inward-sliding operation.

In this embodiment, when the user show the target object in his or her terminal to the others, the user may select the target object by long-pressing it with one hand, and perform the two-finger-outward-sliding operation at any location on the screen of the terminal with another hand during the user long-presses the target object, to trigger switching displaying of the target object to the private displaying mode. In this way, only the target object can be displayed in the private displaying mode.

At the same time, the terminal may detect the multi-point touch event for the target object in the background in real-time, and determine whether the detected multi-point touch event is the first multi-point touch event corresponding to the first multi-point touch operation. When the long-press event for the target object is detected, as well as a two-finger-outward-sliding event at any location on the screen is detected when the long-press event occurs, the terminal can determine that the detected multi-point touch event is the first multi-point touch event corresponding to the first multi-point touch operation.

When the terminal has determined that the detected multi-point touch event is the first multi-point touch event, switching displaying of the target object to the private displaying mode may be triggered, such that only the target object can be displayed in the private displaying mode.

It can be implemented in various ways for switching displaying of the target object to the private displaying mode.

In an exemplary implementation, it may display the target object in full-screen and maintain a screen-locking status when displaying of the target object is switched to the private displaying mode. The terminal may not respond to a touch operation such as clicking, sliding UDRL (up, down, right, left) and the like for the target object anymore, when the terminal is maintained in the screen locking status. In this way, the potential risk of privacy disclosure when the users show the target objects to the others can be reduced.

After showing the target object to the other, the user may also select the target object by long-pressing it with one hand, and perform the two-finger-inward-sliding operation at any location on the screen with another hand, to trigger switching displaying of the target object from the private displaying mode to the default displaying mode.

At the same time, the terminal may further detect the multi-point touch event for the target object in the background in real-time, and determine whether the detected multi-point touch event is the second multi-point touch event corresponding to the second multi-point touch operation. After the two-finger-inward-sliding event at any location on the screen is detected when the long-press event occurs, the terminal can determine that the detected multi-point touch event is the second multi-point touch event corresponding to the second multi-point touch operation.

When the terminal has determined that the detected multi-point touch event is the second multi-point touch event, switching displaying of the target object from the private displaying mode to the default displaying mode may be triggered, the target object is not displayed in full-screen, and the terminal may deactivate the screen-locking status. After deactivating the screen-locking status, the terminal may respond to the touch operation such as clicking, sliding UDRL (up, down, right, left) and the like for the target object.

For example, assuming that the target object is a message in the user terminal, the user may long-press the message with one hand when he/she wants to show the message in the terminal to the others, and the user may perform the two-finger-outward-sliding operation with another hand for the message when he/she long-presses the message, to switch displaying of the message to the private displaying mode. Then the message is displayed in full screen and the terminal is maintained in the screen-locking status. Under such condition, the terminal may not respond to the touch operation such as clicking, sliding UDRL (up, down, right, left) and the like for the message performed by other users any more. Thus other users cannot view the other messages in the same message session, so that it may reduce the risk of privacy disclosure. After showing the message to the others, the user may long-press the message, and perform the two-finger-inward-sliding operation with another hand for the message when long-pressing the message, to switch the message to the default displaying mode, the message may then not be displayed in full screen and the terminal is deactivated from the screen-locking status. After deactivating the screen-locking status, the terminal may respond to the touch operation such as clicking, sliding UDRL (up, down, right, left) and the like for the message as normal.

For another example, assuming that the target object is a picture in the user terminal, the user may long-press the picture with one hand when he/she wants to show the picture in the terminal to the others, and the user may perform the two-finger-outward-sliding operation with another hand for the picture when long-pressing the picture, to switch displaying of the picture to the private displaying mode. Then the picture is displayed in full screen and the terminal is maintained in screen-locking status. Under such condition, the terminal may not respond to the touch operation such as clicking, sliding UDRL (up, down, right, left) and the like for the picture any more. Thus, the others cannot view the other pictures which are undesired to be shown by sliding left or right when they are viewing the picture, so that it may reduce the risk of privacy disclosure. After showing the picture to the others, the user may long-press the picture, and perform the two-finger-inward-sliding operation with another hand for the picture when long-pressing it, to switch displaying of the picture to the default displaying mode. Then the picture is not displayed in full screen and the terminal is deactivated from the screen-locking status. After deactivating the screen-locking status, the terminal may respond to the touch operation such as clicking, sliding UDRL (up, down, right, left) and the like for the picture as normal.

In another exemplary implementation, a private displaying interface can be created in advance when displaying of the target object is switched to the private displaying mode. Then the target object can be moved to the private displaying interface for displaying. The target object can be displayed in full screen or zoom-in displayed by default, when the target object is moved to the private displaying interface.

After the target object is moved to the private displaying interface, the terminal can still respond to the touch operation for the target object performed by user, and the user can still perform the two-finger-outward-sliding or two-finger-inward-sliding operation for the target object to implement the zoom-in or zoom-out operation. Moreover, since the private displaying interface is only used to display the target object, the user can not view the other target objects except for the selected target object when the user can perform the sliding UDRL operations for this target object. Thus, the potential risk of privacy disclosure when the user shows the target object to others can be reduced.

After showing the target object to others, the user may also select the target object by long-pressing it with one hand, and the user may perform the two-finger-inward-sliding operation at any location on the screen with another hand when long-pressing the target object, to trigger switching displaying of the target object from the private displaying mode to the default displaying mode.

At the same time, the terminal may still detect the multi-point touch event for the target object in the background in real-time, and determine whether the detected multi-point touch event is the second multi-point touch event corresponding to the second multi-point touch operation. After the two-finger-inward-sliding event at any location on the screen is detected when the long-press event occurs, the terminal can determine that the detected multi-point touch event is the second multi-point touch event corresponding to the second multi-point touch operation.

When the terminal has determined that the detected multi-point touch event is the second multi-point touch event, switching displaying of the target object from the private displaying mode to the default displaying mode may be triggered, and the target object is moved out of the private interface and the private interface is closed. After the private interface is closed, the terminal can move the target object to a default location.

For example, assuming that the target object is a message in the user terminal, the user may long-press the message with one hand when he/she wants to show the message in the terminal to the others, and the user may perform the two-finger-outward-sliding operation with another hand for the message when long-pressing the message, to move the message to the pre-created private displaying interface for displaying. Under such condition, the terminal can respond to the touch operation such as clicking, sliding UDRL (up, down, right, left) and the like for the message performed by the others as normal. The other users cannot view the other messages in the same message session because the private displaying interface is only used to display the message, so that it may reduce the risk of privacy disclosure.

After showing the message to others, the user may long-press the message with one hand, and perform the two-finger-inward-sliding operation with another hand for the message when long-pressing the message, to switch the message to the default displaying mode, the message is moved out of the private displaying interface and the private displaying interface is closed. After the private interface is closed, the terminal can move the message to the default location in the message session.

For another example, assuming that the target object is a picture in the user terminal, the user may long-press the picture with one hand when he/she wants to show the message in the terminal to the others, and the user may perform the two-finger-outward-sliding operation with another hand for the picture when long-pressing the picture, to move the picture to the pre-created private displaying interface for displaying. Under such condition, the terminal can respond to the touch operation such as clicking, sliding UDRL (up, down, right, left) and the like for the message performed by the others as normal. The others cannot view the other pictures which are undesired to be shown by sliding left or right when they view the picture because the private displaying interface is only used to display the selected picture, so that it may reduce the risk of privacy disclosure.

After showing the picture to the others, the user may long-press the message with one hand, and perform the two-finger-inward-sliding operation with another hand for the picture when long-pressing it, to switch displaying of the picture to the default displaying mode. Then the picture is moved out of the private displaying interface and the private displaying interface is closed. After the private interface is closed, the terminal can move the picture to a default location in a photo album, for example.

The above description about the gesture interaction process between the user and the terminal in details is given with the example where the selecting operation is the long-press operation, the zoom-in gesture operation is the two-finger-outward-sliding operation and the zoom-out gesture operation is the two-finger-inward-sliding operation. Certainly, the zoom-in gesture operation can be defined as other types of gesture operation in practical applications, which will not be limited to the examples given in the present embodiment.

For example, the zoom-in gesture operation may also be a sliding operation in any first direction on the screen or a double click operation at any location on the screen when the user selects the target object by long-pressing it. That is, the user can switch displaying of the target object to the private displaying mode by sliding in any first direction on the screen or double clicking the target object when user selects the target object by long-pressing it. The zoom-out gesture operation may also be the sliding operation in any second direction on the screen or double click operation at any location on the screen when the user selects the target object by long-pressing it. That is, after displaying of the target object is switched to the private displaying mode, the user can switch displaying of the target object from the private displaying mode to the default displaying mode by sliding in any second direction on the screen or double clicking the target object. The first direction and the second direction correspond to the two different directions on the screen. For example, the first direction is directed towards left and the second direction is directed towards right.

In the above embodiments, by detecting a multi-point touch event for a target object, and determining whether the detected multi-point touch event is a predetermined first multi-point touch event, wherein the first multi-point touch event is used to trigger switching displaying of the target object to a private displaying mode, the target object is switched to be displayed in a private displaying mode if the detected multi-point touch event is the first multi-point touch event, to display only the target object in the private displaying mode. Thus, the user can implement switching displaying of the target object to the private displaying mode easily using simple multi-point touch operations, reducing the potential risk of privacy disclosure in a usage scenario where the user shows the target object to the others.

Also, using the multi-point operation to trigger switching displaying of the target object to the private displaying mode is simple to operate, and can avoid the problem of semantic conflict that occurs when displaying of the target object is switched to the private displaying mode using conventional single-point operations. For example, the conventional single-point operations such as click, double-click, long-press operations and the like are generally defined with particular semantics in a terminal system, thus there may be semantic conflicts with the existing semantics in the terminal system when switching displaying of the target object to the private displaying mode is triggered using conventional single-point operations.

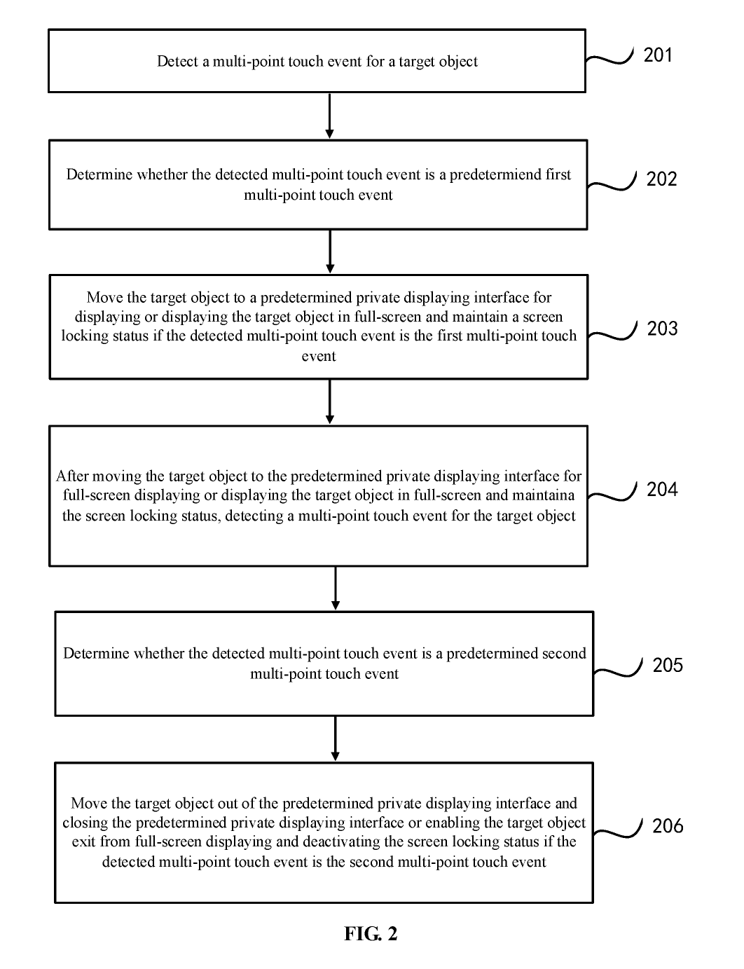

FIG. 2 illustrates a method for displaying a target object, which can be applied in a terminal, according to an exemplary embodiment. The method includes the following steps.

In step 201, a multi-point touch event for a target object is detected.

In step 202, it is determined whether the detected multi-point touch event is a predetermined first multi-point touch event.

In step 203, the target object is moved to a predetermined private displaying interface for displaying, or the target object is displayed in full screen and a screen-locking status is maintained if the detected multi-point touch event is the first multi-point touch event.

In step 204, after moving the target object to the predetermined private displaying interface for full-screen displaying or displaying the target object in full-screen and maintain the screen-locking status, a multi-point touch event for the target object is detected.

In step 205, it is determined whether the detected multi-point touch event is a predetermined second multi-point touch event.

In step 206, the target object is moved out of the predetermined private displaying interface and the predetermined private displaying interface is closed, or the target object is enabled to exit from the full-screen displaying and the screen-locking status is deactivated if the detected multi-point touch event is the second multi-point touch event.

The terminal mentioned above may be a mobile terminal, for example, the terminal may be a touch-screen smart phone. The target object mentioned above may be a text object or an image object. For example, the target object may be a message in the user terminal and may also be a picture in the user terminal. The target object may be other types of objects such as a multimedia object, a window object and the like which are used to show the target object. For example, the target object can also be a window of an application or a multimedia interface of the user terminal.

In this embodiment, the particular multi-touch operations are performed for the target object to be shown when the user shows the target object to the others, and displaying of the target object to be shown is switched to the private displaying mode for displaying.

The particular multi-touch operations mentioned above may be multi-touch operations which are predetermined. The predetermined multi-touch operations may include the first multi-point touch operation used to trigger switching displaying of the target object to the private displaying mode, and the second multi-point touch operation used to trigger restoring displaying of the target object from the private displaying mode to the default displaying mode.

Both the first multi-point touch operation and the second multi-point touch operation mentioned above may be a combination of the predetermined touch operations. For example, the first multi-point touch operation may include a selecting operation for the target object and a zoom-in gesture operation accompanying the selecting operation. The second multi-point touch operation may include the selecting operation for the target object and a zoom-out gesture operation accompanying the selecting operation.

In an implementation illustrated in this embodiment, the selecting operation may be a long-press operation. The zoom-in gesture operation may be a two-finger-outward-sliding operation at any location of a screen of the terminal when the user selects the target object by long-pressing it; the zoom-out gesture operation may be a two-finger-inward-sliding operation at any location on the screen when the user selects the target object by long-pressing it.

In the following, the gesture interaction process between the user and the terminal will be described in details with an example where the selecting operation is the long-press operation, the zoom-in gesture operation is the two-finger-outward-sliding operation and the zoom-out gesture operation is the two-finger-inward-sliding operation.

In this embodiment, when the user shows the target object in his or her terminal to the others, the user may select the target object by long-pressing it with one hand, and the user may further perform the two-finger-outward-sliding operation at any location on the screen of the terminal with another hand when the user long-presses the target object, to trigger switching displaying of the target object to the private displaying mode. In this way, only the target object is displayed in the private displaying mode.

At the same time, the terminal may detect the multi-point touch event for the target object in the background in real-time, and determine whether the detected multi-point touch event is the first multi-point touch event corresponding to the first multi-point touch operation. When the long-press event for the target object is detected, as well as the two-finger-outward-sliding event at any location on the screen is detected when the long-press event occurs, the terminal can determine that the detected multi-point touch event is the first multi-point touch event corresponding to the first multi-point touch operation.

When the terminal has determined that the detected multi-point touch event is the first multi-point touch event, switching displaying of the target object to the private displaying mode that may be triggered, such that only the target object is displayed in the private displaying mode.

Switching displaying of the target object to the private displaying mode may be implemented in various ways.

In an exemplary implementation, the terminal may display the target object in full screen and maintain a screen-locking status when displaying of the target object is switched to the private displaying mode. The terminal may not respond to any touch operation such as clicking, sliding UDRL (up, down, right, left) operation and the like for the target object performed by the user anymore, when it is maintained in the screen-locking status. Thus, the potential risk of privacy disclosure when the user shows the target object to the others can be reduced.

After showing the selected target object to the others, the user may also select the target object by long-pressing it with one hand, and perform the two-finger-inward-sliding operation at any location on the screen with another hand when long-pressing the target object, to trigger switching displaying of the target object from the private displaying mode to a default displaying mode.

At the same time, the terminal may further detect the multi-point touch event for the target object in the background in real-time, and determine whether the detected multi-point touch event is the second multi-point touch event corresponding to the second multi-point touch operation. After the two-finger-inward-sliding event at any location on the screen is detected when the long-press event occurs, the terminal can determine that the detected multi-point touch event is the second multi-point touch event corresponding to the second multi-point touch operation.

When the terminal has determined that the detected multi-point touch event is the second multi-point touch event, switching displaying of the target object from the private displaying mode to the default displaying mode may be triggered, and the target object is not displayed in full screen and the terminal is deactivated from the screen-locking status. After deactivating the screen-locking status, the terminal may respond to the touch operation such as clicking, sliding UDRL (up, down, right, left) operation and the like for the target object as normal.

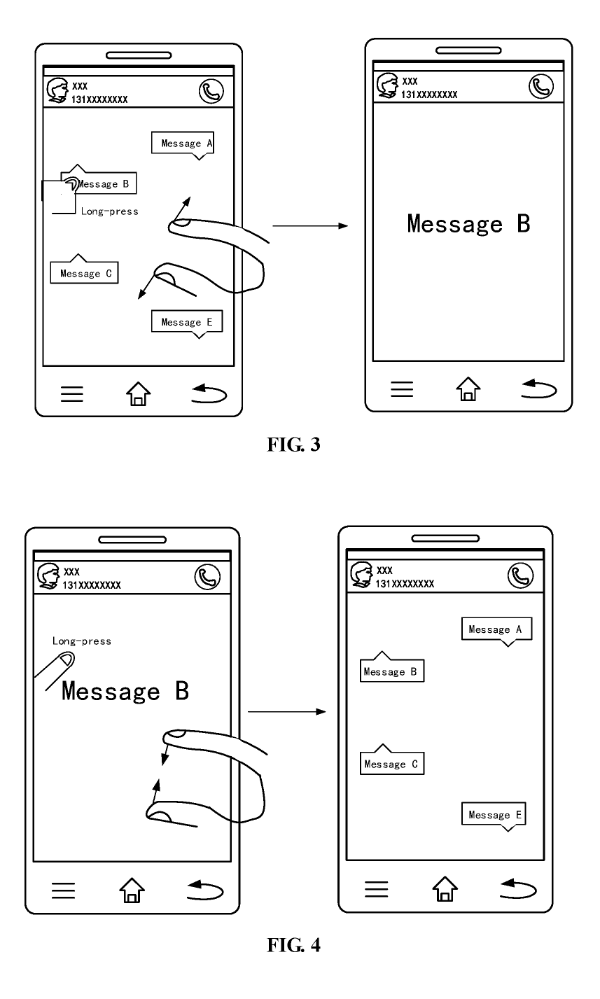

Referring to FIG. 3, for example, assuming that the target object is a message in the user terminal, the user may long-press the message with one hand when he/she wants to show the message in the terminal to the others, and the user may perform the two-finger-outward-sliding operation with another hand for the message when long-pressing the message, to switch displaying of the message to the private displaying mode. Then, the message is displayed in full screen and the terminal is maintained in the screen-locking status. At this time, the terminal may not respond to the touch operation such as clicking, sliding UDRL (up, down, right, left) operation and the like for the message by the others anymore. Thus, the others cannot view the other messages in the same message session, so that it may reduce the risk of privacy disclosure.

Referring to FIG. 4, after showing the selected message to the others, the user may long-press the message with one hand, and perform the two-finger-inward-sliding operation with another hand for the message when long-pressing the message, to switch the message to the default displaying mode. Thus, the message is not displayed in full screen and the terminal is deactivated from the screen-locking status. After deactivating the screen-locking status, the terminal may respond to the touch operation such as clicking, sliding UDRL (up, down, right, left) operation and the like for the message as normal.

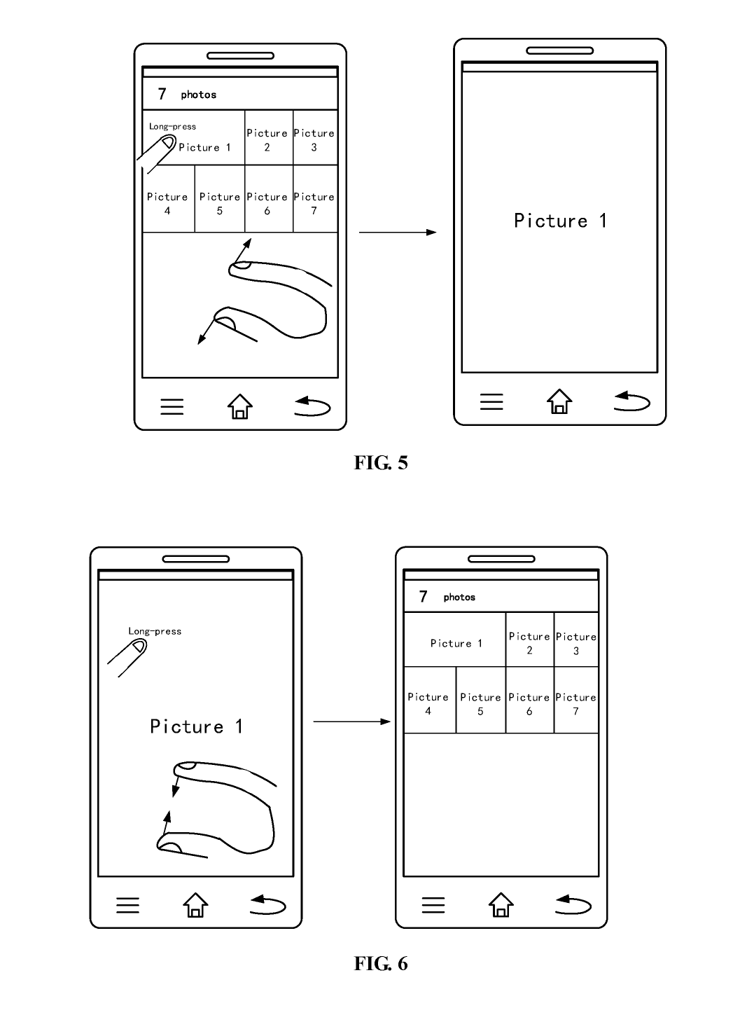

Referring to FIG. 5, for another example, assuming that the target object is a picture in the user terminal, the user may long-press the picture with one hand when he/she wants to show the message in the terminal to the others, and the user may perform the two-finger-outward-sliding operation with another hand for the picture when long-pressing it, to switch displaying of the picture to the private displaying mode, the picture is displayed in full screen and the terminal is maintained in the screen-locking status. At this time, the terminal may not respond to any touch operation such as clicking, sliding UDRL (up, down, right, left) operation and the like for the picture anymore. Thus, the others cannot view the other pictures which are undesired to be shown by sliding left or right when they view the selected picture, so that it may reduce the risk of privacy disclosure.

Referring to FIG. 6, after showing the selected picture to the others, the user may long-press the message, and perform the two-finger-inward-sliding operation with another hand for the picture when long-pressing it, to switch displaying of the picture to the default displaying mode. Then the picture is not displayed in full screen and the terminal is deactivated from the screen-locking status. After deactivating the screen-locking status, the terminal may respond to the touch operation such as clicking, sliding UDRL (up, down, right, left) operation and the like for the picture as normal.

In another exemplary implementation, a private displaying interface can be created in advance when displaying of the target object is switched to the private displaying mode. Then the target object is moved to the private displaying interface for displaying. The target object can be displayed in full screen or zoom-in displayed by default when the target object is moved to the private displaying interface.

After the target object is moved to the private displaying interface, the terminal can still respond to the touch operation for the target object performed by the user, and the user can still perform the two-finger-outward-sliding or two-finger-inward-sliding operation for the target object to implement the zoom-in or zoom-out operation. Moreover, because the private displaying interface is only used to display the target object, the user can not view the other target object except for the target object when performing the sliding UDRL operations for this target object. In this way, the potential risk of privacy disclosure when the user shows the target object to the others can be reduced.

After showing the target object to the others, the user may also select the target object by long-pressing it, and the user may perform the two-finger-inward-sliding operation at any location on the screen with another hand when long-pressing the target object, to trigger switching displaying of the target object from the private displaying mode to the default displaying mode.

At the same time, the terminal may detect the multi-point touch event for the target object in the background in real-time, and determine whether the detected multi-point touch event is the second multi-point touch event corresponding to the second multi-point touch operation. After the two-finger-inward-sliding event at any location on the screen is detected when the long-press event occurs, the terminal can that determine the detected multi-point touch event is the second multi-point touch event corresponding to the second multi-point touch operation.

When the terminal has determined that the detected multi-point touch event is the second multi-point touch event, switching displaying of the target object from the private displaying mode to the default displaying mode may be triggered, the target object is moved out of the private interface and the private interface is closed. After the private interface is closed, the terminal can move the target object to the default location.

For example, assuming that the target object is a message in the user terminal, the user may long-press the message with one hand when he/she wants to show the message in the terminal to the others, and the user may perform the two-finger-outward-sliding operation with another hand for the message when long-pressing it, to move the message to the pre-created private displaying interface for displaying. At this time the terminal can respond to the touch operation such as clicking, sliding UDRL (up, down, right, left) and the like for the message as normal. The others cannot view the other messages in the same message session because the private displaying interface is only used to display the message, so that it may reduce the risk of privacy disclosure.

After showing the selected message to the others, the user may long-press the message with one hand, and perform the two-finger-inward-sliding operation with another hand for the message when long-pressing it, to switch displaying of the message to the default displaying mode. Then the message is moved out of the private displaying interface and the private displaying interface is closed. After the private interface is closed, the terminal can move the message to the default location in the message session.

For another example, assuming that the target object is a picture in the user terminal, when he/she wants to show the message in the terminal to the others, the user may long-press the picture with one hand, and perform the two-finger-outward-sliding operation with another hand for the picture when long-pressing it, to move the picture to the pre-created private displaying interface for displaying. At this time, the terminal can respond to the touch operation such as clicking, sliding UDRL (up, down, right, left) and the like for the message as normal. The others cannot view the other pictures which are undesired to be shown by sliding left or right when they view the picture, because the private displaying interface is only used to display the selected picture. Thus, it may reduce the risk of privacy disclosure.

After showing the picture to the others, the user may long-press the message with one hand, and perform the two-finger-inward-sliding operation with another hand for the picture when long-pressing it, to switch displaying of the picture to the default displaying mode, the picture is moved out of the private displaying interface and the private displaying interface is closed. After the private interface is closed, the terminal can move the picture to the default location in a photo album.

The gesture interaction process between the user and the terminal is described above in details with the example where the selecting operation is the long-press operation, the zoom-in gesture operation is the two-finger-outward-sliding operation and the zoom-out gesture operation is the two-finger-inward-sliding operation. The zoom-in gesture operation can be defined as other types of gesture operation in practical applications, which is not limited in the present embodiment.

For example, the zoom-in gesture operation may also be the sliding operation in any first direction on the screen or double click at any location on the screen when the user selects the target object by long-pressing it. That is, the user can switch displaying of the target object to the private displaying mode by sliding in any first direction on the screen or double clicking the target object when the user selects the target object by long-pressing it. The zoom-out gesture operation may also be the sliding operation in any second direction on the screen or double clicking at any location on the screen when the user selects the target object by long-pressing it. That is, after displaying of the target object is switched to the private displaying mode, the user can switch the target object from the private displaying mode to the default displaying mode by sliding in any second direction on the screen or double clicking the target object. The first direction and the second direction corresponds to the two different directions on the screen respectively. For example, the first direction is directed towards left and the second direction is directed towards right.

In the above embodiments, by detecting a multi-point touch event for a target object, and determining whether the detected multi-point touch event is a predetermined first multi-point touch event, wherein the first multi-point touch event is used to trigger switching displaying of the target object to a private displaying mode, displaying of the target object is switched to the private displaying mode if the detected multi-point touch event is the first multi-point touch event, to display only the target object in the private displaying mode. Then, the user can implement switching displaying of the target object to the private displaying mode easily using simple multi-point touch operations, thereby reducing the potential risk of privacy disclosure in a usage scenario where the user shows the target object to the others.

Also, using the multi-point operation to trigger switching displaying of the target object to the private displaying mode is simple to operate, and can avoid the problem of semantic conflict that occurs when displaying of the target object is switched to the private displaying mode using conventional single-point operations. For example, the conventional single-point operations such as click, double-click, long-press operation and the like are generally defined with particular semantics in a terminal system, thus there may be semantic conflicts with the existing semantics in terminal system when switching displaying of the target object to the private displaying mode is triggered using conventional single-point operation.

A device for displaying a target object is provided, which corresponds to the method for displaying the target object.

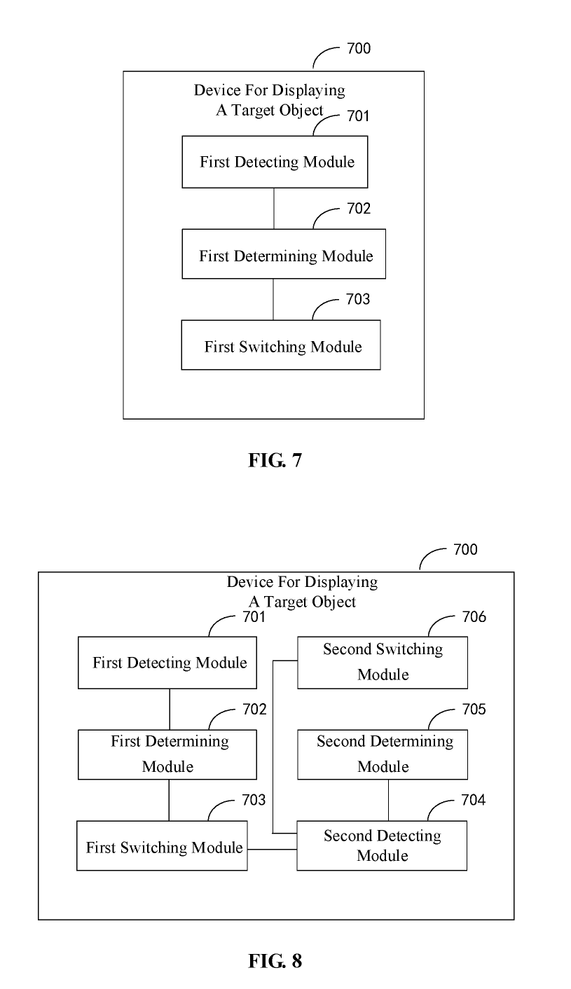

FIG. 7 is a block diagram illustrating a device for displaying a target object according to an exemplary embodiment.

FIG. 7 illustrates a device 700 for displaying a target object according to an exemplary embodiment, which includes: a first detecting module 701, a first determining module 702, and a first switching module 703.

The first detecting module 701 is configured to detect a multi-point touch event for the target object.

The first determining module 702 is configured to determine whether the multi-point touch event detected by the first detecting module is a predetermined first multi-point touch event, wherein the first multi-point touch event is used to trigger switching displaying of the target object to a private displaying mode.

The first switching module 703 is configured to switch displaying of the target object to the private displaying mode if the first determining module determines that the detected multi-point touch event is the first multi-point touch event, such that only the target object is displayed in the private displaying mode.

In the above embodiments, by detecting a multi-point touch event for a target object, and determining whether the detected multi-point touch event is a predetermined first multi-point touch event, wherein the first multi-point touch event is used to trigger switching displaying of the target object to a private displaying mode, the target object is switched to be displayed in a private displaying mode if the detected multi-point touch event is the first multi-point touch event, to display only the target object in the private displaying mode. Thus, the user can implement switching displaying of the target object to the private displaying mode easily using simple multi-point touch operations, reducing the potential risk of privacy disclosure in a usage scenario where the user shows the target object to the others.

Referring to FIG. 8, FIG. 8 is a block diagram illustrating another device according to an exemplary embodiment, which is based on the embodiment illustrated in FIG. 7. The device 700 may further include a second detecting module 704, a second determining module 705 and a second switching module 706.

The second detecting module 704 is configured to detect a multi-point touch event for the target object after the first switching module 703 switches displaying of the target object to the private displaying mode.

The second determining module 705 is configured to determine whether the multi-point touch event detected by the second detecting module 704 is a predetermined second multi-point touch event. The second multi-point touch event is used to trigger restoring displaying of the target object from the private displaying mode to a default displaying mode.

The second switching module 706 is configured to switch displaying of the target object from the private displaying mode to a default displaying mode if the second determining module 704 determines that the detected multi-point touch event is the second multi-point touch event.

Referring to FIG. 9, FIG. 9 is a block diagram illustrating another device according to an exemplary embodiment, which is based on the embodiment illustrated in FIG. 7. The first switching module 703 may include a first displaying sub-module 703A.

The first displaying sub-module 703A is configured to move the target object to a predetermined private displaying interface for displaying.

It should be note that the structure of the first displaying sub-module 703A illustrated in the device embodiment of FIG. 9 may also be included in the device embodiment of FIG. 8, which is not limited by the present disclosure.

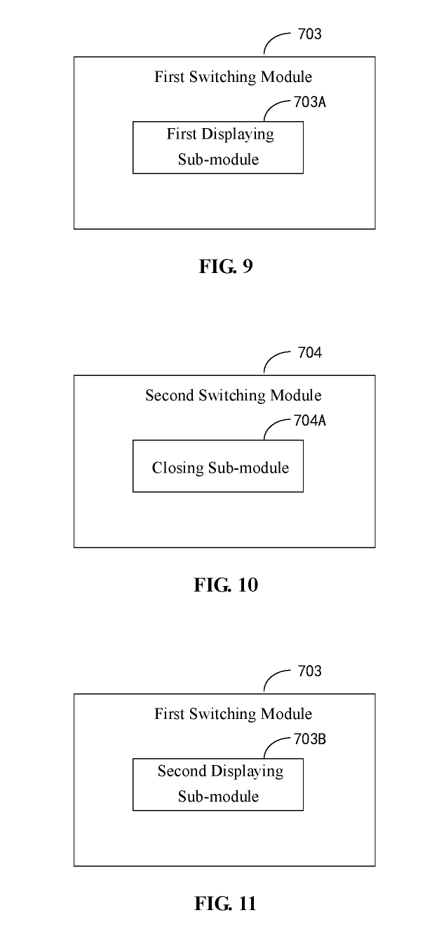

Referring to FIG. 10, FIG. 10 is a block diagram illustrating another device according to an exemplary embodiment, which is based on the embodiment illustrated in FIG. 8. The second switching module 704 may include a closing sub-module 704A.

The closing module 704A is configured to move the target object out of the predetermined private displaying interface and close the predetermined private displaying interface.

It should be noted that the structure of the closing module 704A illustrated in the device embodiment of FIG. 10 may also be included in the device embodiment of FIG. 7 or FIG. 9, which is not limited by the present disclosure.

Referring to FIG. 11, FIG. 11 is a block diagram illustrating another device according to an exemplary embodiment, which is based on the embodiment illustrated in FIG. 7. The first switching module 703 may include a second displaying sub-module 703B.

The second displaying sub-module is configured to display the target object in full screen and maintain a screen locking status.

It should be noted that the structure of the second displaying sub-module 703B illustrated in the device embodiment of FIG. 11 may also be included in the device embodiment of FIG. 8-10, which is not limited by the present disclosure.

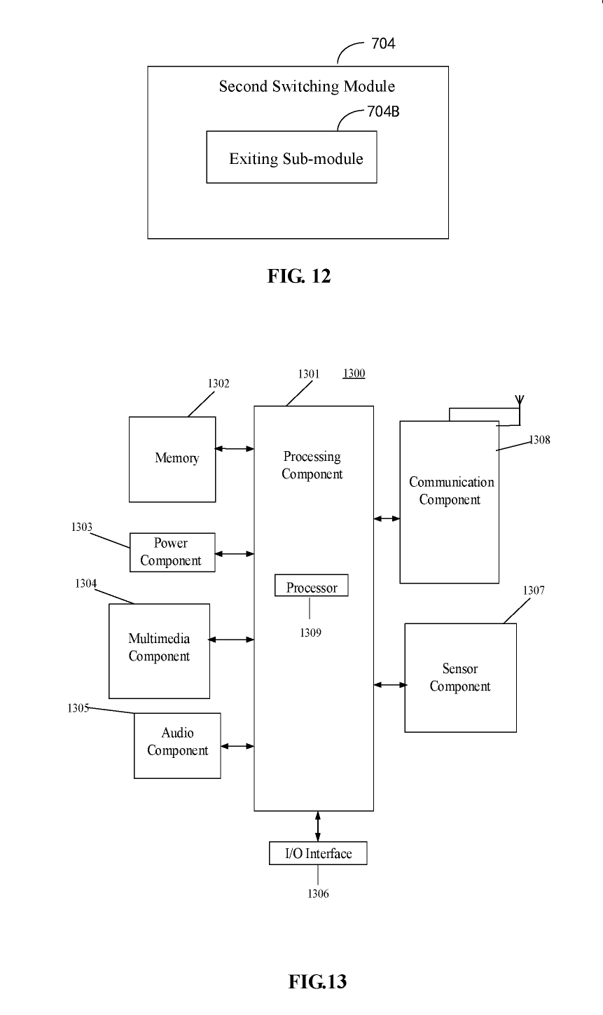

Referring to FIG. 12, FIG. 12 is a block diagram illustrating another device according to an exemplary embodiment, which is based on the embodiment illustrated in FIG. 8. The second switching module 704 may include an exiting sub-module 704B.

The exiting sub-module 704B configured to enable the target object to exit from full-screen displaying and deactivating the screen-locking status.

It should be note that the structure of the exiting sub-module 704B illustrated in device embodiment of FIG. 12 may also be comprised in device embodiment of FIG. 7 or FIG. 9-11, the present disclosure will not limit for this.

In the above embodiments, the first multi-point touch event detected by the first detecting module 701 includes a first selecting event and a zoom-in gesture event for the target object, and a time period during which the zoom-in gesture event occurs is within a time period during which the first electing event occurs.

The second multi-point touch event detected by the second detecting module 704 includes a second selecting event and a zoom-out gesture event for the target object, and a time period during which the zoom-out gesture event occurs is within a time period during which the second selecting event occurs.

The first selecting event detected by the first detecting module 701 and the second selecting event detected by the second detecting module 704 both include a long-press event. The zoom-in gesture event detected by the first detecting module 701 includes a two-finger-outward-sliding event at any location on the screen; and the zoom-out gesture event detected by the second detecting module 704 includes a two-finger-inward-sliding event at any location on the screen.

The target object to be detected by the first detecting module 701 and the second detecting module 704 includes an image object or text object.

With respect to the devices in the above embodiments, the specific manners for performing operations for individual modules therein have been described in detail in the embodiments regarding the methods, which will not be elaborated herein.

The device embodiments generally correspond to the method embodiments, thus, certain details of these embodiments have been described in the paragraphs of the method embodiments. The device embodiment described above are exemplary only, wherein the modules described as separate components may or may not separate in physically, the components illustrated as modules may or not be physical modules, that is, the components may be located in the same place or may be distributed on multiple network modules. A portion of or all of the modules can be selected to implement the present disclosure as desired. It will be understood and practiced by ordinary skilled in the art without inventiveness effort.

Accordingly, a device for displaying a target object is provided in the present disclosure, including: a processor; a memory for storing the instructions executable by the processor; wherein the processor is configured to: detect a multi-point touch event for the target object; determine whether the detected multi-point touch event is a predetermined first multi-point touch event, wherein the first multi-point touch event is used to trigger switching displaying of the target object to a private displaying mode; if the detected multi-point touch event is the first multi-point touch event, switching displaying the target object to the private displaying mode, such that only the target object is displayed in the private displaying mode.

Accordingly, a terminal is provided in the present disclosure, including: a memory, and one or more programs executable by one or more processors which are stored in the memory, the one or more programs include the instructions for: detecting a multi-point touch event for a target object; determining whether the detected multi-point touch event is a predetermined first multi-point touch event, wherein the first multi-point touch event is used to trigger switching displaying of the target object to a private displaying model; if the detected multi-point touch event is the first multi-point touch event, switching displaying of the target object to the private displaying mode, such that only the target object is displayed in the private displaying mode.

FIG. 13 is a structure diagram illustrating a device for displaying the target object according to an exemplary embodiment.

As shown in FIG. 13, illustrating a device 1300 for displaying the target object according to an exemplary embodiment, the device 1300 may be a mobile phone, a computer, a digital broadcast terminal, a messaging device, a gaming console, a tablet, a medical device, exercise equipment, a personal digital assistant, and the like.

Referring to FIG. 13, the device 1300 may include one or more of the following components: a processing component 1301, a memory 1302, a power component 1303, a multimedia component 1304, an audio component 1305, an input/output (I/O) interface 1306, a sensor component 1307, and a communication component 1308.

The processing component 1301 typically controls overall operations of the device 1300, such as the operations associated with display, telephone calls, data communications, camera operations, and recording operations. The processing component 1301 may include one or more processors 1309 to execute instructions to perform all or part of the steps in the above described methods. Moreover, the processing component 1301 may include one or more modules which facilitate the interaction between the processing component 1301 and other components. For instance, the processing component 1301 may include a multimedia module to facilitate the interaction between the multimedia component 808 and the processing component 1301.

The memory 1302 is configured to store various types of data to support the operation of the device 1300. Examples of such data include instructions for any applications or methods operated on the device 1300, contact data, phonebook data, messages, pictures, video, etc. The memory 1302 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1303 provides power to various components of the device 1303. The power component 1303 may include a power management system, one or more power sources, and any other components associated with the generation, management, and distribution of power for the device 1300.

The multimedia component 1304 includes a screen providing an output interface between the device 1300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1304 includes a front camera and/or a rear camera. The front camera and the rear camera may receive an external multimedia datum while the device 1300 is in an operation mode, such as a photographing mode or a video mode. Each of the front camera and the rear camera may be a fixed optical lens system or have optical focusing and zooming capability.

The audio component 1305 is configured to output and/or input audio signals. For example, the audio component 1305 includes a microphone (“MIC”) configured to receive an external audio signal when the device 1300 is in an operation mode, such as a call mode, a recording mode, and a voice recognition mode. The received audio signal may be further stored in the memory 1302 or transmitted via the communication component 1308. In some embodiments, the audio component 1305 further includes a speaker to output audio signals.

The I/O interface 1302 provides an interface between the processing component 1301 and peripheral interface modules, the peripheral interface modules being, for example, a keyboard, a click wheel, buttons, and the like. The buttons may include, but are not limited to, a home button, a volume button, a starting button, and a locking button.

The sensor component 1307 includes one or more sensors to provide status assessments of various aspects of the device 1300. For instance, the sensor component 1307 may detect an open/closed status of the device 1300, relative positioning of components (e.g., the display and the keypad, of the device 1300), a change in position of the device 1300 or a component of the device 1300, a presence or absence of user contact with the device 1300, an orientation or an acceleration/deceleration of the device 1300, and a change in temperature of the device 1300. The sensor component 1307 may include a proximity sensor configured to detect the presence of a nearby object without any physical contact. The sensor component 1307 may also include a light sensor, such as a CMOS or CCD image sensor, for use in imaging applications. In some embodiments, the sensor component 1307 may also include an accelerometer sensor, a gyroscope sensor, a magnetic sensor, a pressure sensor, or a temperature sensor.

The communication component 1308 is configured to facilitate communication, wired or wirelessly, between the device 1300 and other devices. The device 1300 can access a wireless network based on a communication standard, such as WiFi, 2G or 3G or a combination thereof. In an exemplary embodiment, the communication component 1308 receives a broadcast signal or broadcast associated information from an external broadcast management system via a broadcast channel. In an exemplary embodiment, the communication component 1308 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 1302 in the device 1300, for performing the above-described methods. For example, the non-transitory computer-readable storage medium may be a ROM, a RAM, a CD-ROM, a magnetic tape, a floppy disc, an optical data storage device, and the like.

When the instructions in the storage medium is executed by the processor of the mobile terminal, the mobile terminal is enabled to perform a method for displaying a target object, including: detecting a multi-point touch event for the target object; determining whether the detected multi-point touch event is a predetermined first multi-point touch event, wherein the first multi-point touch event is used to trigger switching displaying of the target object to a private displaying mode; if the detected multi-point touch event is the first multi-point touch event, switching displaying of the target object to the private displaying mode, such that only the target object is displayed in the private displaying mode.

Other embodiments of the invention will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for displaying a target object, comprising:
detecting a multi-point touch event for the target object;
determining whether the detected multi-point touch event is a predetermined first multi-point touch event, wherein the first multi-point touch event is used to trigger switching displaying of the target object to a private displaying mode; and
switching displaying of the target object to the private display mode if the detected multi-point touch event is the first multi-point touch event, such that only the target object is displayed in the private displaying mode.

2. The method of claim 1, after switching displaying of the target object to the private displaying mode, the method further comprising:
detecting a multi-point touch event for the target object;
determining whether the detected multi-point touch event is a predetermined second multi-point touch event, wherein the second multi-point touch event is used to trigger restoring displaying of the target object from the private displaying mode to a default displaying mode; and
switching displaying of the target object from the private displaying mode to the default displaying mode if the detected multi-point touch event is the second multi-point touch event.

3. The method of claim 2, wherein switching displaying of the target object to the private displaying mode comprises:
moving the target object to a predetermined private displaying interface for displaying;
and switching displaying of the target object from the private displaying mode to the default displaying mode comprises:
moving the target object out of the predetermined private displaying interface and closing the predetermined private displaying interface.

4. The method of claim 2, wherein switching displaying of the target object to the private displaying mode comprises:
displaying the target object full-screen and maintaining a screen-locking status;
and switching displaying of the target object from the private displaying mode to the default displaying mode comprises:
enabling the target object to exit from the full-screen displaying and deactivating the screen-locking status.

5. The method of claim 2, wherein the first multi-point touch event comprises a first selecting event and a zoom-in gesture event for the target object, and a time period during which the zoom-in gesture event occurs is within a time period during which the first selecting event occurs contains; and
the second multi-point touch event comprises a second selecting event and a zoom-out gesture event for the target object, and a time period during which the zoom-out gesture event is within a time period during which the second selecting event occurs.

6. The method of claim 5, wherein both the first selecting event and the second selecting event comprise a long-press event; the zoom-in gesture event comprises a two-finger-outward-sliding event on a screen; and the zoom-out gesture event comprises a two-finger-inward-sliding event on the screen.

7. The method of claim 1, wherein the target object comprises an image object or a text object.

8. A device for displaying a target object, comprising:
a processor; and
a memory for storing instructions executable by the processor;
wherein the processor is configured to:
detect a multi-point touch event for the target object;
determine whether the detected multi-point touch event is a predetermined first multi-point touch event, wherein the first multi-point touch event is used to trigger switching displaying of the target object to a private displaying mode; and
switch displaying of the target object to the private displaying mode if the detected multi-point touch event is the first multi-point touch event, such that only the target object is displayed in the private displaying mode.

9. The device of claim 8, wherein the processor is further configured to:
detect a multi-point touch event for the target object after switching displaying of the target object to the private displaying mode;
determine whether the detected multi-point touch event is a predetermined second multi-point touch event, wherein the second multi-point touch event is used to trigger restoring displaying of the target object from the private displaying mode to a default displaying mode; and
switch displaying of the target object from the private displaying mode to the default displaying mode if the detected multi-point touch event is the second multi-point touch event.

10. The device of claim 9, wherein the processor is further configured to:
move the target object to a predetermined private displaying interface for displaying; and
move the target object out of the predetermined private displaying interface and close the predetermined private displaying interface.

11. The device of claim 9, wherein the processor is further configured to:
display the target object full-screen and maintain a screen-locking status; and
enable the target object to exit from the full-screen displaying and deactivate the screen-locking status.

12. The device of claim 9, wherein
the first multi-point touch event comprises a first selecting event and a zoom-in gesture event for the target object, and a time period during which the zoom-in gesture event occurs is within a time period during which the first selecting event occurs contains;
the second multi-point touch event comprises a second selecting event and a zoom-out gesture event for the target object, and a time period during which the zoom-out gesture event is within a time period during which the second selecting event occurs.

13. The device of claim 12, wherein
both the first selecting event and the second selecting event comprise a long-press event;
the zoom-in gesture event comprises a two-finger-outward-sliding event on a screen; and the zoom-out gesture event comprises a two-finger-inward-sliding event on the screen.

14. The device of claim 9, wherein the target object comprises an image object or a text object.

15. A non-transitory computer-readable storage medium having stored therein instructions that, when executed by a processor of a device, causes the device to perform a method for displaying a target object, the method comprising:
detecting a multi-point touch event for the target object;
determining whether the detected multi-point touch event is a predetermined first multi-point touch event, wherein the first multi-point touch event is used to trigger switching displaying of the target object to a private displaying mode; and
switching displaying of the target object to the private displaying mode if the detected multi-point touch event is the first multi-point touch event, such that only the target object is displayed in the private displaying mode.
